(19) United States
(12) Patent Application Publication
(10) Pub. No.: US 2013/0313787 A1
(43) Pub. Date: Nov. 28, 2013

(54) SEAL STRUCTURE FOR GROMMET

(71) Applicant: Masashi Fujiki, Yokkaichi-shi (JP)

(72) Inventor: Masashi Fujiki, Yokkaichi-shi (JP)

(73) Assignee: SUMITOMO WIRING SYSTEMS, LTD., Yokkaichi-shi, Mie (JP)

(21) Appl. No.: 13/982,937

(22) PCT Filed: Oct. 20, 2011
(86) PCT No.: PCT/JP2011/074113

§ 371 Date: Jul. 31, 2013

(30) Foreign Application Priority Data
Mar. 14, 2011 (JP) 2011-055550

(51) Int. Cl. F16L 5/10

(52) U.S. Cl. CPC F16L 5/10
USPC 277/606

(57) ABSTRACT

The present invention improves sealing performance for a grommet mounted on a metal pipe and attached to a through-hole in a vehicle body panel, the metal pipe sheathing an exterior of a wire harness. The grommet includes a small diameter cylinder tightly attached to the metal pipe inserted therethrough, and an enlarged diameter portion tightly attached to and held on the vehicle body panel on a periphery of the through-hole. A metal bracket is fixated to the enlarged diameter portion, the metal bracket covering an exterior surface side of the enlarged diameter portion and including fixers bolted to the vehicle body panel. An exterior circumferential surface of the small diameter cylinder includes annular recesses and protrusions alternating in a length direction, while an interior circumferential surface includes a plurality of annular seal lips in the length direction. A clamp is fitted around an exterior of the small diameter cylinder.

### FIELD OF THE INVENTION

The present invention relates to a seal structure for a grommet. Specifically, the present invention increases sealing performance of a grommet mounted on a metal pipe and attached to a through-hole in a vehicle body panel, the metal pipe sheathing an exterior of a wire harness routed in a vehicle.

### BACKGROUND OF THE INVENTION

Conventionally, thick wires connecting devices mounted in a rear area of a vehicle and devices mounted in a front area of the vehicle are often wired in an underbody (below a floor panel) in hybrid or electric automobiles. As shown in FIG. 6, in order to draw thick wires W1, W2, and W3 (wired in the underbody) into a chamber interior (X) from a vehicle exterior (Y) in a vicinity of a battery pack in the rear area of the vehicle, a grommet 100 made of rubber or elastomer is mounted on the wires W1, W2, and W3 and a large diameter cylinder 102 of the grommet 100 is fitted into and fixated to a through-hole 103 provided in a vehicle body panel P in Japanese Patent Laid-open Publication No. 2004-166431 (Patent Literature 1). With this configuration, the through-hole 103 in the vehicle body panel P is sealed by the large diameter cylinder 102 of the grommet 100. In addition, the wires W1, W2, and W3 are inserted therethrough in a state of tight attachment to a small diameter cylinder 101 via a seal lip 101a, the small diameter cylinder 101 being continuous with a first terminal side of the large diameter cylinder 102. The wires W1, W2, and W3 are then wound with tape (T) to tape winding tongues 101b on a forefront end of the small diameter cylinder 101, thereby ensuring the sealing performance between the small diameter cylinder 101 of the grommet 100 and the wires W1, W2, and W3 and improving water- and dust-proofing performance.

Meanwhile, as shown in FIG. 7, Japanese Patent Laid-open Publication No. 2010-215010 (Patent Literature 2) teaches sheathing an exterior of a wire harness W/H with a metal pipe 104, the wire harness W/H being configured with thick wires W and wired in an underbody. By sheathing the exterior of the wire harness W/H with the metal pipe 104 in this way, permeation of noise can be prevented while heat radiation is increased and the wires W can be protected from rocks and foreign bodies kicked up from a road surface during driving.

### RELATED ART

### Patent Literature

Patent Literature 1: Japanese Patent Laid-open Publication No. 2004-166431

Patent Literature 2: Japanese Patent Laid-open Publication No. 2010-215010

### SUMMARY OF THE INVENTION

### Problems to be Solved by the Invention

However, when the metal pipe 104 is inserted through a small diameter cylinder 111 of a grommet 110 made of rubber or elastomer (similar to Patent Literature 1) and an enlarged diameter cylinder 112 of the grommet 110 is fixated to the through-hole 103 in the vehicle body panel P, in order to draw the metal pipe 104 sheathing the exterior of the wire harness W/H into the chamber interior X from the vehicle exterior Y (the underbody, for example; see FIG. 8), seal lips 111a on an interior surface of the small diameter cylinder 111 may lift up and the sealing performance between the metal pipe 104 and the small diameter cylinder 111 may deteriorate due to the small diameter cylinder 111 (which is flexible) reflecting movement of the highly rigid metal pipe 104 and elongating more than necessary due to effects from an external force applied to the metal pipe 104. In addition, the sealing performance between the enlarged diameter cylinder 112 and the vehicle body panel P may also encounter problems due to flexure of the entire grommet 110.

The present invention has as an object to increase sealing performance of a grommet mounted on a metal pipe and attached to a through-hole in a vehicle body panel, the metal pipe sheathing an exterior of a wire harness routed in a vehicle.

### Means for Solving the Problems

In order to solve the above problems, the present invention provides a seal structure for a grommet made of rubber or an elastomer mounted on a metal pipe and attached to a through-hole in a vehicle body panel, the metal pipe sheathing an exterior of a wire harness routed in a vehicle.

The grommet includes a small diameter cylinder and an enlarged diameter portion. The small diameter cylinder is tightly attached to the metal pipe inserted therethrough. The enlarged diameter portion is continuous with a first end of the small diameter cylinder and is tightly attached and fixated to a vehicle body panel on a periphery of the through-hole.

A metal bracket is attached to the enlarged diameter portion, the metal bracket covering an exterior surface side of the enlarged diameter portion and including fixers bolted to the vehicle body panel.

Meanwhile, annular recesses and protrusions are provided on an exterior circumferential surface of the small diameter cylinder, the recesses and protrusions alternating in a length direction, while a plurality of annular seal lips are provided at intervals in the length direction on an interior circumferential surface of the small diameter cylinder.

A clamp is fitted around the exterior of and fixated to the small diameter cylinder, through which the metal pipe is inserted, the clamp being configured by a first divided body and a second divided body having semi-annular shapes in cross-section. A first end of each of the first and second divided bodies is connected by a thin-walled hinge so as to be freely openable and closeable, while a second end of each includes a locking portion forming a mutually locking connection. In addition, protrusions and recesses engaging with the recesses and protrusions on the small diameter cylinder are provided on the interior circumferential surface of the first and second divided bodies, the protrusions and recesses alternating in a length direction.

The fixers on the metal bracket are bolted to the vehicle body panel.

As described above, the present invention has a configuration in which the plurality of annular seal lips are provided at intervals in the length direction on the interior circumferential surface of the small diameter cylinder of the grommet, the small diameter cylinder tightly attached to the metal pipe inserted therethrough. In addition, the annular recesses and protrusions are provided on the exterior circumferential surface, alternating in the length direction. Moreover, the clamp is fitted around the exterior of and fixated to the small diameter cylinder, through which the metal pipe is inserted, the clamp including on the interior circumferential surface thereof the protrusions and recesses which engage with the recesses and protrusions of the small diameter cylinder. Thus, even when an external force or the like is applied to the highly rigid metal pipe inserted through the small diameter cylinder, the clamp fitted around the exterior of the small diameter cylinder can inhibit excessive stretching of the flexible small diameter cylinder and can prevent the seal lips tightly attached to the metal pipe from lifting up. Moreover, misalignment of the grommet can be prevented by the engagement of the protrusions and recesses on the clamp and the small diameter cylinder. Accordingly, the sealing performance between the metal pipe and the small diameter cylinder can be maintained, and thus good waterproofing and dust-proofing results can be obtained.

The clamp is configured with the first and second divided bodies each connected at the first end by the thin-walled hinge and including at the second end the locking portions that form a mutually locking connection. Thus, attaching the clamp to the small diameter cylinder can be readily and reliably performed with a “one touch” operation. The clamp is preferably a molded resin article.

As described above, the metal bracket is attached to the enlarged diameter portion of the grommet, which is tightly attached to and held on the vehicle body panel on the periphery of the through-hole. The metal bracket covers the exterior surface side of the enlarged diameter portion and includes fixers bolted to the vehicle body panel. By bolting the fixers to the vehicle body panel, the sealing performance between the enlarged diameter portion and the vehicle body panel can be increased.

The enlarged diameter portion preferably includes an enlarged diameter cylinder through which the metal pipe is inserted and a flange projecting in a diameter direction from an exterior circumferential surface of the enlarged diameter cylinder. An annular metal bracket engagement recess is preferably provided at a flange projection position on the exterior circumferential surface of the enlarged diameter cylinder, the metal bracket engagement recess engaging with a small diameter-side terminal edge of the metal bracket to cover an annular exterior surface and circumferential wall of the flange in an “L” shape in cross-section. The pair of fixers preferably include bolt holes and project bent at a right angle from opposite positions on a bottom end of the flange circumferential wall. Meanwhile, an annular outer seal lip tightly attached to the vehicle body panel on the periphery of the through-hole is preferably provided on an interior surface of the flange.

The small diameter-side terminal edge of the metal bracket is engaged with the metal bracket engagement recess provided on the exterior circumferential surface of the enlarged diameter cylinder. In addition, the annular exterior surface and circumferential wall of the flange are covered in an “L” shape in cross-section and are bolted to the vehicle body panel by the pair of opposing fixers. Thus, the flange is pressed toward the vehicle body panel in a state where the metal bracket is stable, and the outer seal lip on the interior surface of the flange is firmly attached to the vehicle body panel. The sealing performance between the enlarged diameter portion (the flange) and the vehicle body panel can thus be increased.

Moreover, the enlarged diameter cylinder on the enlarged diameter portion is preferably continuous with the first end of the small diameter cylinder via an accordion-folded flexible portion. With this configuration, even when an external force, vibration, or the like is applied to the metal pipe tightly attached to and inserted through the small diameter cylinder, detrimental effects can be prevented from influencing attachment performance between the vehicle body panel and the outer seal lip provided on the interior surface of the flange on the enlarged diameter portion.

The wire harness is preferably wired in an underbody, the metal pipe sheathing an exterior of the wire harness, and the grommet is preferably attached to the through-hole in the vehicle body panel separating the underbody from a chamber interior in a rear area of the vehicle.

In a vehicle such as a hybrid or electric automobile, the wire harness is often sheathed by the metal pipe and wired in the underbody, the wire harness being configured with thick wires connecting devices mounted in a front area of the vehicle (such as a motor) and devices mounted in the chamber interior in the rear area of the vehicle (such as an inverter). As described above, the grommet having the above-described seal structure is attached to the through-hole in the vehicle body panel separating the underbody, which is exposed to water, and the chamber interior in the rear area of the vehicle, where water must be avoided. Thus, even when vibration or impact is applied to the metal pipe passing through the underbody, the sealing performance between the grommet and the metal pipe can be ensured, as can the sealing performance between the grommet and the vehicle body panel, and intrusion of rainwater or foreign bodies into the chamber interior in the rear area of the vehicle can be prevented.

### Effect of the Invention

As described above, the present invention has a configuration in which a plurality of annular seal lips are provided at intervals in a length direction on an interior circumferential surface of a small diameter cylinder of a grommet, the small diameter cylinder being tightly attached to a metal pipe inserted therethrough. In addition, annular recesses and protrusions are provided on an exterior circumferential surface, alternating in the length direction. Moreover, a clamp is fitted around an exterior of and fixated to the small diameter cylinder through which the metal pipe is inserted, the clamp including on an interior circumferential surface thereof protrusions and recesses which engage with the recesses and protrusions of the small diameter cylinder. Thus, even when an external force or the like is applied to the highly rigid metal pipe inserted through the small diameter cylinder, the clamp fitted around the exterior of the small diameter cylinder can inhibit excessive stretching of the flexible small diameter cylinder and can prevent the seal lips tightly attached to the metal pipe from lifting up. Moreover, misalignment of the grommet can be prevented by the engagement of the protrusions and recesses on the clamp and the small diameter cylinder. Accordingly, the sealing performance between the metal pipe and the small diameter cylinder can be maintained, and thus good waterproofing and dust-proofing results can be obtained.

As described above, the metal bracket is attached to the enlarged diameter portion of the grommet, which is tightly attached to and held on the vehicle body panel on the periphery of the through-hole. The metal bracket covers the exterior surface side of the enlarged diameter portion and includes fixers bolted to the vehicle body panel. By bolting the fixers to the vehicle body panel, the sealing performance between the enlarged diameter portion and the vehicle body panel can be increased.

### BRIEF DESCRIPTION OF THE DRAWINGS

FIG. 1 illustrates a grommet according to an embodiment of the present invention to which a metal bracket is attached, the grommet being mounted to a metal pipe sheathing an exterior of a wire harness, where (A) is a perspective view and (B) is a cross-sectional view along a line A-A.

FIG. 2 is a cross-sectional view illustrating a state in which the grommet mounted on the metal pipe is attached to a through-hole in a vehicle body panel.

FIG. 3 is a perspective view of a clamp fitted around and fixated to an exterior of a small diameter cylinder of the grommet.

FIG. 4 is an explanatory diagram illustrating an attachment position of the grommet.

FIG. 5 illustrates another example of a seal structure in the present invention.

FIG. 6 illustrates a conventional example.

FIG. 7 illustrates a conventional example.

FIG. 8 illustrates a conventional example.

### MODE FOR CARRYING OUT THE INVENTION

Hereafter, an embodiment of the present invention is described with reference to the drawings.

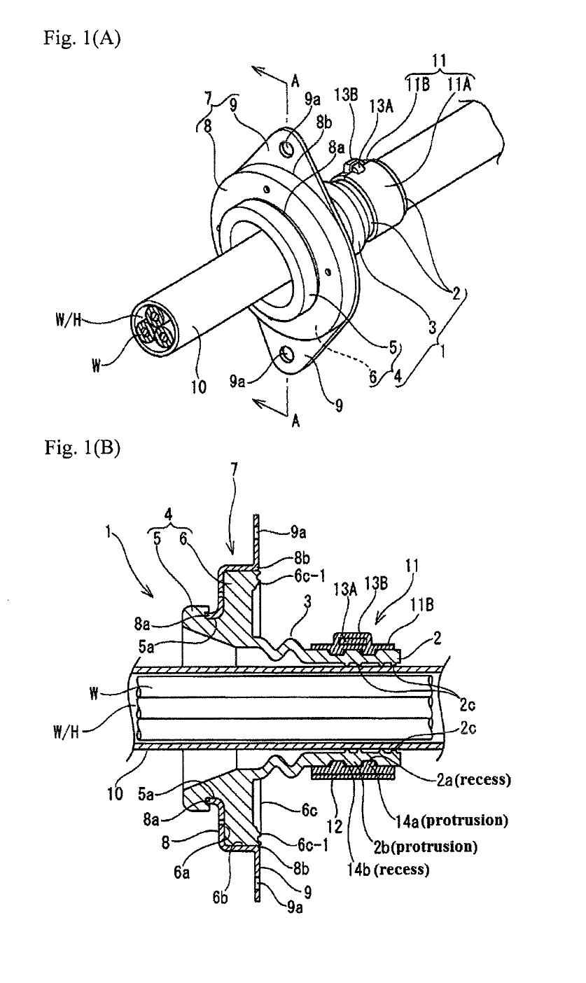

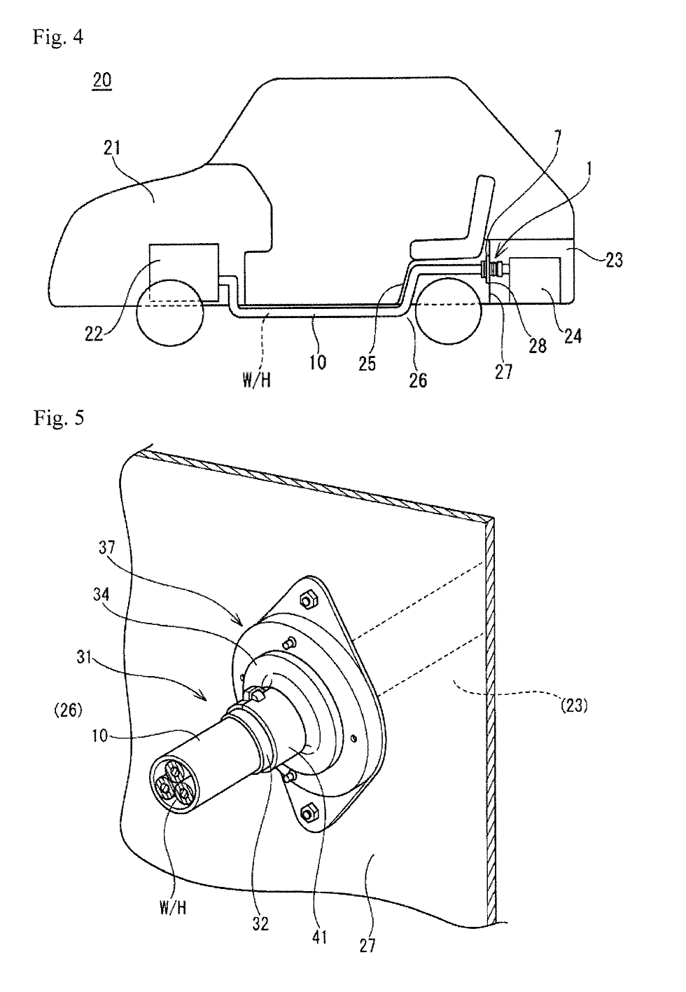

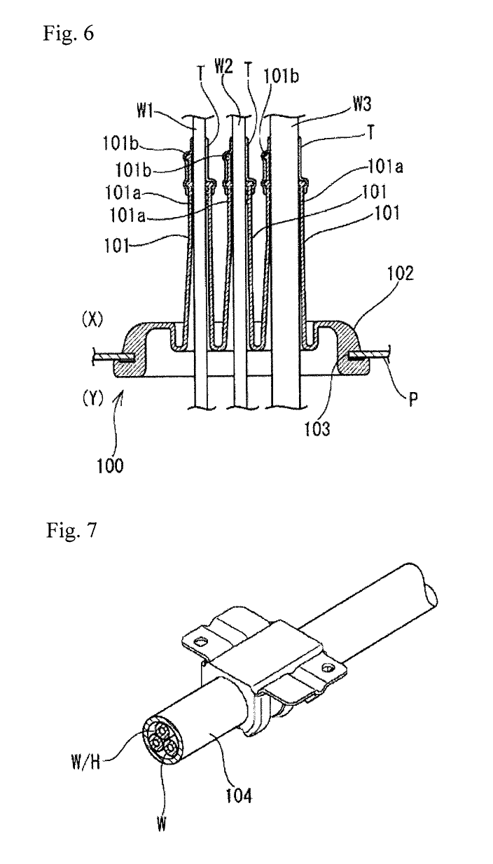

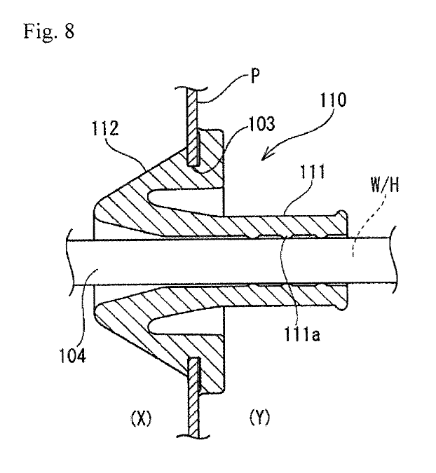

The embodiment of the present invention is illustrated in FIGS. 1-4. As shown in FIG. 4, in the present embodiment, a wire harness W/H is routed along an underbody 26, below a floor panel 25, the wire harness W/H being configured with three thick wires W connecting a motor 22 and an inverter 24. The motor 22 is mounted in an engine compartment 21 of a hybrid automobile 20, while the inverter 24 is mounted in a rear chamber interior 23 (a space beneath a luggage compartment). An exterior of the wire harness W/H is sheathed by a metal pipe 10 made of aluminum or iron. In order to draw the wire harness W/H routed along the underbody into the rear chamber interior 23, a grommet 1 is mounted on the metal pipe 10 sheathing the exterior of the wire harness W/H. In addition, the grommet 1 is attached to a through-hole 28 provided in a vehicle body panel 27 separating the underbody (chamber exterior) 26 and the rear chamber interior 23.

Specifically, the grommet 1 is configured with a molded rubber article and, as shown in FIG. 1, the grommet 1 includes a small diameter cylinder 2 and an enlarged diameter portion 4. The small diameter cylinder 2 is tightly attached to the metal pipe 10 inserted therethrough. The enlarged diameter portion 4 is continuous with a first end of the small diameter cylinder 2 via an accordion-folded flexible portion 3. In the present embodiment, the enlarged diameter portion 4 includes an enlarged diameter cylinder 5 and an annular flange 6. The metal pipe 10 is inserted through the enlarged diameter cylinder 5, which widens in diameter toward a forefront end thereof. The flange 6 projects in a diameter direction from an exterior circumferential surface at an intermediate position in a length direction of the enlarged diameter cylinder 5.

Annular recesses 2a and protrusions 2b are provided on an exterior circumferential surface of the small diameter cylinder 2, the recesses and protrusions alternating in a length direction, while a plurality of annular seal lips 2c for tight attachment to the metal pipe 10 are provided at intervals on an interior circumferential surface of the small diameter cylinder 2.

In addition, the grommet 1 according to the present embodiment has a structure in which an interior surface 6c of the flange 6 includes an annular outer seal lip 6c-1 pressing against and tightly attaching to the vehicle body panel 27 on a periphery of the through-hole 28, and a metal bracket 7 is attached so as to cover an annular exterior surface 6a and circumferential wall 6b of the flange 6. An annular metal bracket engagement recess 5a is provided at a flange projection position on the exterior circumferential surface of the enlarged diameter cylinder 5, the metal bracket engagement recess 5a engaging with a small diameter-side terminal edge 8a of the metal bracket 7.

The small diameter-side terminal edge 8a of the metal bracket 7 engages with the metal bracket engagement recess 5a on the enlarged diameter cylinder 5 to pre-assemble the grommet 1 and the metal bracket 7 as one unit. The metal bracket 7 is configured with a cover 8 and a pair of fixers 9. The cover 8 engages the small diameter-side terminal edge 8a with the metal bracket engagement recess 5a to cover the exterior surface 6a and circumferential wall 6b of the flange 6 in an “L” shape in cross-section. The pair of fixers 9 project bent at a right angle from opposite positions on a large diameter-side terminal edge 8b of the cover 8, positioned on a lower end of the flange circumferential wall 6b. Each of the fixers 9 includes a bolt hole 9a for bolting to the vehicle body panel 27.

The grommet 1 with the metal bracket 7 attached is mounted on the metal pipe 10, then a clamp 11 made of a resin (shown in FIG. 3) is fitted around an exterior of and fixated to the small diameter cylinder 2 through which the metal pipe 10 is inserted. The clamp 11 is configured with a first divided body 11A and a second divided body 11B, which have semi-annular shapes in cross-section and each respectively fit around an exterior of one half-circumference and another half-circumference of the small diameter cylinder 2. A first end of each of the first and second divided bodies 11A and 11B is connected by a thin-walled hinge 12 so as to be freely openable and closeable. In addition, a second end of each forms a locking portion mutually locking and connecting the first and second divided bodies 11A and 11B. A locking tab 13A is provided on the first divided body 11A and a locking frame 13B is provided on the second divided body 11B. Moreover, an interior circumferential surface of the first and second divided bodies 11A and 11B includes annular protrusions 14a and recesses 14b alternating in a length direction, the protrusions 14a and recesses 14b engaging with the recesses 2a and protrusions 2b provided on the exterior circumferential surface of the small diameter cylinder 2.

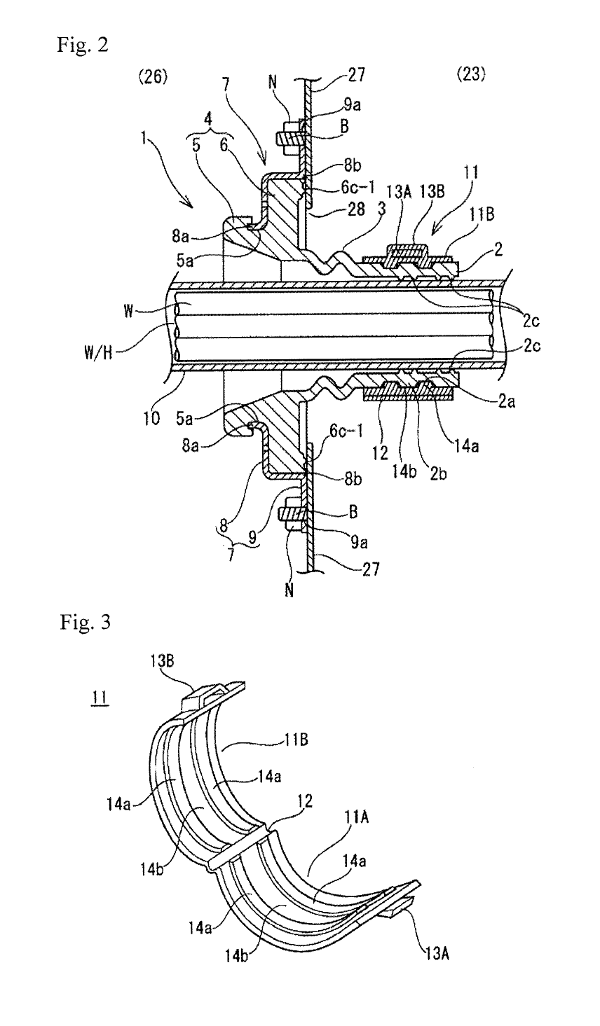

The grommet 1 is attached to the through-hole 28 in the vehicle body panel 27, the grommet 1 having the clamp 11 fitted around the exterior of and fixated to the small diameter cylinder 2, through which the metal pipe 10 is inserted. Specifically, the small diameter cylinder 2 of the grommet 1 is inserted through the through-hole 28 into the rear chamber interior 23 from the chamber exterior 26 side. Then, in a state where the vehicle body panel 27 on the periphery of the through-hole 28 is tightly attached to the outer seal lip 6c-1 on the interior surface of the flange 6 of the enlarged diameter portion 4, the fixers 9 on the metal bracket 7 are bolted to the vehicle body panel 27. In the present embodiment, a stud bolt B sunk into the vehicle body panel 27 in the vicinity of a peripheral edge of the through-hole 28 and projecting toward the chamber exterior 26 side is inserted through the bolt hole 9a on each of the fixers 9 and is fastened in place by a weld nut N (FIG. 2).

As described above, the plurality of annular seal lips 2c are provided at intervals in the length direction on the interior circumferential surface of the small diameter cylinder 2 of the grommet 1, the small diameter cylinder 2 being tightly attached to the metal pipe 10 inserted therethrough. In addition, the annular recesses 2a and protrusions 2b are provided on the exterior circumferential surface, alternating in the length direction. In addition, the present embodiment has a configuration in which the clamp 11 is fitted around the exterior of and fixated to the small diameter cylinder 2, through which the metal pipe 10 is inserted, the clamp 11 including on the interior circumferential surface thereof the protrusions 14a and recesses 14b which engage with the recesses 2a and protrusions 2b of the small diameter cylinder 2. Thus, even when an external force or the like is applied to the highly rigid metal pipe 10 inserted through the small diameter cylinder 2, the clamp 11 fitted around the exterior of the small diameter cylinder 10 can inhibit excessive stretching of the flexible small diameter cylinder 2 and can prevent the seal lips 2c tightly attached to the metal pipe 10 from lifting up. Moreover, misalignment of the grommet 1 can be prevented by the engagement of the protrusions and recesses on the clamp 11 and the small diameter cylinder 2 (engagement between the recesses 2a and the protrusions 14a, and engagement between the protrusions 2b and the recesses 14b). Accordingly, the sealing performance between the metal pipe 10 and the small diameter cylinder 2 of the grommet 1 can be maintained, and thus good waterproofing and dust-proofing results can be obtained.

The clamp 11 is configured with the first and second divided bodies each connected at the first end by the thin-walled hinge 12 and including at the second end the locking tab 13A and the locking frame 13B, respectively, which form a mutually locking connection. Thus, attaching the clamp 11 to the small diameter cylinder 2 can be readily and efficiently performed with a “one touch” operation.

Moreover, as described above, the annular outer seal lip 6c-1 is provided on the interior surface of the flange 6, the outer seal lip 6c-1 pressing against and attaching tightly to the vehicle body panel 27 on the periphery of the through-hole 28, the flange 6 projecting in the diameter direction from the exterior peripheral surface of the enlarged diameter cylinder 5 on the enlarged diameter portion 4. Further, the flange 6 is configured such that the metal bracket 7 is attached to the flange 6, the metal bracket 7 covering the exterior surface 6a and the circumferential wall 6b of the flange 6 in an “L” shape in cross-section. In addition, the metal bracket 7 includes the pair of fixers 9 in opposite positions, the fixers 9 being bolted to the vehicle body panel 27. Thus, the flange 6 is pressed toward the vehicle body panel 27 in a state where the metal bracket 7 is stable and the outer seal lip 6c-1 on the interior surface 6c of the flange 6 is firmly attached to the vehicle body panel 27. The sealing performance between the enlarged diameter portion 4 and the vehicle body panel 27 can thus be increased.

As described above, the enlarged diameter cylinder 5 on the enlarged diameter portion 4 is continuous with the first end of the small diameter cylinder 2 via the accordion-folded flexible portion 3. Therefore, even when an external force, vibration, or the like is applied to the metal pipe 10 inserted through and tightly attached to the small diameter cylinder 2, detrimental effects can be prevented from influencing attachment performance between the vehicle body panel 27 and the outer seal lip 6c-1 on the interior surface 6c of the flange 6 on the enlarged diameter portion 4.

Moreover, in the present embodiment, the small diameter cylinder 2 is positioned on the chamber interior 23, while the metal bracket 7 is positioned on the chamber exterior 26. However, the opposite positioning is also acceptable. In other words, the small diameter cylinder 2 may be positioned on the chamber exterior 26 and the metal bracket 7 may be positioned on the chamber interior 23.

In addition, as in a grommet 31 shown in FIG. 5, the present invention may also be configured such that a small diameter cylinder 32 and a metal bracket 37 are both positioned on the chamber exterior 26, the small diameter cylinder 32 having the metal pipe 10 tightly attached and inserted therethrough and having a clamp 41 fitted around an exterior of and fixated to the small diameter cylinder 32, the metal bracket 37 being attached to an enlarged diameter portion 34 and bolted to the vehicle body panel 27.

### DESCRIPTION OF REFERENCE NUMERALS

1 Grommet

2 Small diameter cylinder

2a Recess

2b Protrusion

2c Seal lip

4 Enlarged diameter portion

5 Enlarged diameter cylinder

5a Metal bracket engagement recess

6 Flange

6a Exterior surface

6b Circumferential wall

6c Interior surface

6c-1 Outer seal lip

7 Metal bracket

8 Cover

8a Small diameter-side terminal edge

9 Fixer

9a Bolt hole

10 Metal pipe

11 Clamp

11A First divided body

11B Second divided body

12 Thin-walled hinge

13A Locking tab

13B Locking frame

14a Protrusion

14b Recess

23 Rear chamber interior

26 Underbody

27 Vehicle body panel

28 Through-hole

1. A seal structure for a grommet made of rubber or an elastomer mounted on a metal pipe and attached to a through-hole in a vehicle body panel, the metal pipe sheathing an exterior of a wire harness routed in a vehicle, the seal structure for the grommet comprising:
a small diameter cylinder tightly attached to the metal pipe inserted therethrough; and
an enlarged diameter portion continuous with a first end of the small diameter cylinder and tightly attached to and held on the vehicle body panel on a periphery ofthe through-hole, wherein
a metal bracket is attached to the enlarged diameter portion, the metal bracket covering an exterior surface side of the enlarged diameter portion and including fixers bolted to the vehicle body panel,
annular recesses and protrusions are provided on an exterior circumferential surface of the small diameter cylinder alternating in a length direction, while a plurality of annular seal lips are provided at intervals in a length direction on an interior circumferential surface of the small diameter cylinder, and
a clamp is fitted around the exterior of and fixated to the small diameter cylinder through which the metal pipe is inserted, the clamp comprising a first divided body and a second divided body having semi-annular shapes in cross-section, wherein
a first end of each of the first and second divided bodies is connected by a thin-walled hinge so as to be freely openable and closeable, while a second end of each of the first and second divided bodies includes a locking portion forming a mutually locking connection; and
protrusions and recesses engaging with the recesses and protrusions on the small diameter cylinder are provided on the interior circumferential surface of the first and second divided bodies, the protrusions and recesses alternating in a length direction.

2. The seal structure for the grommet according to claim 1, wherein the enlarged diameter portion comprises:
an enlarged diameter cylinder through which the metal pipe is inserted; and
a flange projecting in a diameter direction from an exterior circumferential surface of the enlarged diameter cylinder, wherein
the metal bracket covers an annular exterior surface and circumferential wall of the flange in an “L” shape in cross-section by engaging a small diameter-side terminal edge with an annular metal bracket engagement recess provided at a flange projection position on the exterior circumferential surface of the enlarged diameter cylinder,
the fixers project bent at a right angle from opposite positions on a bottom end of the circumferential wall of the flange, the fixers including bolt holes, and
an annular outer seal lip tightly attached to the vehicle body panel on the periphery of the through-hole is provided on an interior surface of the flange.

3. The seal structure for the grommet according to claim 2, wherein the enlarged diameter cylinder on the enlarged diameter portion is continuous with the first end of the small diameter cylinder via an accordion-folded flexible portion.

4. The seal structure for the grommet according to claim 1, wherein the wire harness sheathed by the metal pipe is wired in an underbody, and
the grommet is attached to the through-hole in the vehicle body panel separating the underbody from a chamber interior in a rear area of the vehicle.

5. The seal structure for the grommet according to claim 2, wherein the wire harness sheathed by the metal pipe is wired in an underbody, and
the grommet is attached to the through-hole in the vehicle body panel separating the underbody from a chamber interior in a rear area of the vehicle.

6. The seal structure for the grommet according to claim 3, wherein the wire harness sheathed by the metal pipe is wired in an underbody, and
the grommet is attached to the through-hole in the vehicle body panel separating the underbody from a chamber interior in a rear area of the vehicle.
